(19) United States
(12) Patent Application Publication
(10) Pub. No.: US 2021/0018119 A1
(43) Pub. Date: Jan. 21, 2021

(54) PIPE CONNECTION JOINTS WITH FLEXIBLE FUNCTION

(71) Applicant: Jore Innovation, LLC, Ronan, MT (US)

(72) Inventor: Matthew Benart JORE, Ronan, MT (US)

(21) Appl. No.: 16/931,614

(22) Filed: Jul. 17, 2020

Related U.S. Application Data
(60) Provisional application No. 62/875,538, filed on Jul. 18, 2019.

(51) Int. Cl. F16L 13/10; F16L 27/103; F16L 27/107; F16L 27/113

(52) U.S. Cl. CPC F16L 13/103; F16L 27/103; F16L 25/009; F16L 27/113; F16L 27/107

(57) ABSTRACT

In one embodiment, pipe connection joints are constructed using two materials, a flexible material and a rigid material, which are fixedly attached to form a pipe connection joint that provides a few degrees of flex in order to allow for mis-alignment of pipe ends and to reduce stress at the joint. The flexible pipe connection joints are made in a variety of nominal angles, configurations, and sizes and each of the individual pipe connection joints can be flexed in any direction a few degrees from the nominal angle.

### CROSS REFERENCE TO RELATED APPLICATION

This Application claims the benefit of U.S. Provisional Application No. 62/875,538, filed on Jul. 18, 2019, the entirety of which are incorporated by reference herein.

### TECHNICAL FIELD

The present disclosure is generally related to pipe connection joints with flexible function.

### BACKGROUND

Piping is used in many industries for many different applications, including piping as it relates to the installation and connection in residential and commercial buildings, walkways and landscapes, and other environments of piping for channeling water, wastewater, or other liquids and gases. In a typical installation, segmented piping is channeled throughout a structure or substrate and connected, segment to segment, using fixed straight or fixed angled joints and connectors to complete the network of piping that is intended to distribute a liquid or gas from a source to one or more desired locations throughout the structures or substrates. Oftentimes, at a particular connecting point where pipe segments are joined to form a specific angle, the actual angle may be slightly off from the fixed, or rigid, angle of a standard joint. In this case, the installer needs to stress the rigid joint or segments of pipe to insert and affix pipe segments to the joint.

### SUMMARY OF THE INVENTION

In one embodiment, pipe connection joints are constructed using two materials, a flexible material and a rigid material, which are fixedly attached to form a pipe connection joint that provides a few degrees of flex to allow for mis-alignment of pipe ends and to reduce stress at the joint. The flexible pipe connection joints are made in a variety of nominal angles, configurations, and sizes and each of the individual pipe connection joints can be flexed in any direction a few degrees from the nominal angle.

### BRIEF DESCRIPTION OF THE DRAWINGS

Many aspects of certain embodiments of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of a view of an embodiment of a flexible pipe connection joint illustrating an example of the flex of a pipe connection joint constructed with a nominal one hundred eighty degree, or straight, angle.

FIG. 2 is a schematic diagram of a view of an embodiment of a flexible pipe connection joint illustrating an example of the flex of a pipe connection joint constructed with a nominal ninety degree angle.

FIG. 3 is a schematic diagram of a view of embodiments of flexible pipe connection joints illustrating examples of flexible pipe connection joints constructed with nominal one hundred eighty degree angle (3A), ninety degree angle (3B), nominal forty-five degree angle (3C), and nominal twenty-two and a half degree angle (3D), respectively.

FIG. 4 is a schematic diagram of a view of an embodiment of a flexible pipe connection joint illustrating an example of the flex of a pipe connection joint constructed with a “T” arrangement having two nominal ninety degree angles in two directions.

FIG. 5 is a schematic diagram of a view of an embodiment of a flexible pipe connection joint illustrating an example of the flex of a pipe connection joint constructed with a cross or “+” shape having four nominal ninety degree angles in four directions.

### DETAILED DESCRIPTION OF EXAMPLE EMBODIMENTS

The present invention relates to pipe connection joints that are constructed to provide a few degrees of flex and that are affixed to pipe ends using conventional affixing means, such as primer and pipe adhesives and other means. In particular, certain embodiments of the present invention include pipe connection joints that are constructed of at least two materials, a rigid material and a flexible material. The rigid material forms the connecting end portions of the flexible pipe connection joints and the flexible material forms the middle portion of the flexible pipe connection joints.

Digressing briefly, as explained above, in a typical installation, segmented piping is channeled throughout a structure or substrate and connected, segment to segment, using fixed straight or fixed angled joints and connectors to complete the network of piping that is intended to distribute liquid or gas from a source to one or more desired locations throughout the structures or substrates. Oftentimes, at a particular connecting point where pipe segments are joined to form a specific angle, the actual angle may be slightly off from the fixed, or rigid, angle of a standard joint. In this case, the installer needs to stress the rigid joint or segments of pipe to insert and affix pipe segments to joint. To address this and/or other connection challenges, certain embodiments of a flexible pipe connection joint as disclosed herein that can flex a few degrees in any direction so that the joint connection is de-stressed. In one embodiment, a flexible pipe connection joint includes flexible joints wherein a portion of the joint is a flexible material that is molded or attached fixably to portions of the joint that are rigid. The rigid portions are of similar material and sizing to accommodate standard affixing means, such as epoxies, primers, glues, and/or other bonding substances. Evidence of this relatively common need for joint connection flexibility exists in the marketplace. For instance, there are flexible fittings and joints made of a rubber or other substance that are used to join segments of pipe. However, these flexible fittings and joints use a clamping mechanism to seal the pipe ends from leaks. In contrast, certain embodiments of a flexible pipe connection joint enable the use of standard affixing means, such as using standard adhesives.

Having summarized certain features of a flexible pipe connection joint of the present invention, reference will now be made in detail to the description of a flexible pipe connection joint as illustrated in the drawings. While a flexible pipe connection joint will be described in connection with these drawings, there is no intent to limit it to the embodiment or embodiments disclosed herein. For instance, the illustrations and descriptions of the disclosed flexible pipe connection joint are not intended to be limiting, as there are a number of different configurations that might be utilized to achieve the utility of flexibility, usability, and joint stress reduction brought by the present invention according to variations that are contemplated to be within the scope of the invention as would be appreciated by one having ordinary skill in the art. Note that one or more features described for one embodiment may be combined or replaced with one or more features of other embodiments. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the scope of the disclosure as defined by the appended claims. Further, it should be appreciated in the context of the present disclosure that the claims are not necessarily limited to the particular embodiments set out in the description. Like-numbered reference numbers refer to the same or similar components.

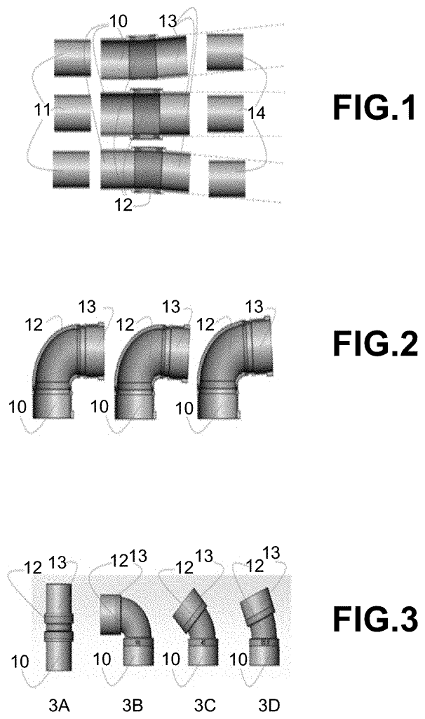

In one embodiment, and referring to FIG. 1, a flexible pipe connection joint comprises a rigid first end portion 10 constructed to be affixed to a connecting pipe end 11, a flexible middle portion 12 permanently affixed to first end portion 10, and a rigid second end 13 constructed to be affixed to a connecting pipe end 14 and permanently affixed to flexible middle portion 12. FIG. 1 illustrates one example of the flexibility of flexible pipe connection joint, where the depicted middle arrangement shows connections to a connecting pipe 14 along a common central axis and the above and below arrangements show the connections to the connecting pipe 14 according to a few degrees of flex relative to the common central axis.

In another embodiment, as shown in FIG. 2, a flexible pipe connection joint is constructed with a specific nominal angle, such as ninety degrees, and flexible middle portion 12 allows a few degrees of flex, while rigid end portions 10 and 13 allow for the use of standard affixing means, such as primer and epoxy, to affix the flexible pipe connection joint to connecting pipe ends 11 and 14 (FIG. 1).

Referring now to FIG. 3, some embodiments of a flexible pipe connection joint are constructed with specific nominal angles, such as one hundred eighty degrees (3A), ninety degrees (3B), forty-five degrees (3C), and twenty-two and one half degrees (3D), and flexible middle portion 12 allows a few degrees of flex, while rigid end portions 10 and 13 allow for the use of standard affixing means, such as primer and epoxy, to affix the flexible pipe connection joint to connecting pipe ends 11 and 14 (FIG. 1).

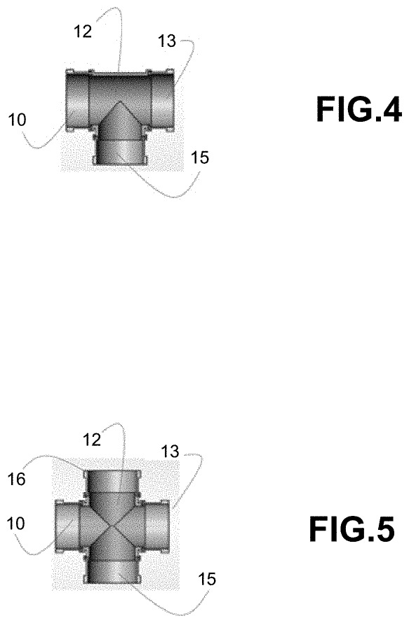

Referring now to FIG. 4, some embodiments of a flexible pipe connection joint are constructed with specific nominal angles, such as ninety degrees, a flexible middle portion 12, which allows a few degrees of flex, first rigid end portion 10 and second rigid end portion 13 and a third rigid end portion 15 affixed to flexible middle portion 12 while rigid end portions 10, 13, and 15 allow for the use of standard affixing means, such as primer and epoxy, to affix the flexible pipe connection joint to connecting pipe ends 11 and 14 (FIG. 1) and other pipe ends (not shown). In this illustrative example, a T-shaped arrangement is shown.

Referring now to FIG. 5, some embodiments of a flexible pipe connection joint are constructed with specific nominal angles, such as ninety degrees, a flexible middle portion 12, which allows a few degrees of flex, first rigid end portion 10 and second rigid end portion 13 and a third rigid end portion 15 and fourth rigid end portion 16, each end portion 10, 13, 15, and 16 affixed to flexible middle portion 12 while rigid end portions 10, 13, 15, and 16 allow for the use of standard affixing means, such as primer and epoxy, to affix the flexible pipe connection joint to connecting pipe ends 11 and 14 (FIG. 1) and other pipe ends (not shown). In this illustrative example, a longitudinal axis running through end portions 15 and 16 is orthogonal to a transverse axis running through end portions 10 and 13 (e.g., in a cross or “+” shaped configuration).

In addition, certain embodiments of methods are disclosed. In one embodiment, a method for producing a pipe joint comprising a first end portion, a middle portion, and a second end portion, said end portions made of a rigid material molded in a first mold cavity and said middle portion made of a flexible material molded in a second mold cavity incorporated into the first mold cavity so that the rigid end portions and the flexible middle portion are fixedly attached to each other.

In one embodiment, a method for producing a pipe joint comprising a first end portion, a middle portion, and a second end portion wherein said middle portion made of a flexible material is molded in a first mold cavity and said end portions made of a rigid material are molded in a second mold cavity incorporated into the first mold cavity so that the flexible middle portion and the rigid end portions are fixedly attached to each other.

In one embodiment, a method for producing a pipe joint comprising a first end portion, a middle portion, and a second end portion, said end portions molded of a rigid material and said middle portion molded of a flexible material and said end portions and said middle portion are fixedly attached to each other using an affixing means.

In one embodiment, a method for producing a pipe joint comprising at least one end portion, a middle portion, and at least one other end portion wherein said middle portion made of a flexible material is molded in a first mold cavity and said end portions made of a rigid material are molded in a second mold cavity incorporated into the first mold cavity so that the flexible middle portion and the rigid end portions are fixedly attached to each other.

In one embodiment, a method for producing a pipe joint comprising at least one end portion, a middle portion, and at least one other end portion, said end portions molded of a rigid material and said middle portion molded of a flexible material and said end portions and said middle portion are fixedly attached to each other.

In one embodiment, a method for producing a pipe joint comprising at least one end portion, a middle portion, and at least one other end portion, said end portions molded of a rigid material and said middle portion molded of a flexible material and said end portions and said middle portion are fixedly attached to each other using an affixing means.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality.

What is claimed is:

1. A pipe joint comprising a first end portion fixedly attached to a middle portion fixedly attached to a second end portion, said end portions made of a rigid material and said middle portion made of a flexible material.

2. The pipe joint of claim 1, wherein the end portions are made of material compatible with any one of a plurality of adhesives used to connect pipes and pipe fittings.

3. The pipe joint of claim 1, wherein said middle portion is made of material compatible with any one of a plurality of chemicals, fluids, or gases.

4. The pipe joint of claim 1, said second end portion fixedly attached to at least one other flexible middle portion that is fixedly attached to at least one other rigid portion.

5. A method for producing a pipe joint comprising a first end portion, a middle portion, and a second end portion, said end portions made of a rigid material molded in a first mold cavity and said middle portion made of a flexible material molded in a second mold cavity incorporated with the first mold cavity so that the rigid end portions and the flexible middle portion are fixedly attached to each other.

6. The method of claim 5, wherein said first and second end portions and said middle portion are fixedly attached to each other using an affixing means.

7. The method of claim 5, wherein said first and second end portions and said middle portion are fixedly attached to each other using an affixing means.
